(19) United States
(12) Patent Application Publication
(10) Pub. No.: US 2016/0265188 A1
(43) Pub. Date: Sep. 15, 2016

(54) WEAR PLATE FOR BOX BLADE

(71) Applicant: Caterpillar Inc., Peoria, IL (US)

(72) Inventors: Karl S. Kuriger, Raleigh, NC (US); Michael T. Ryan, Raleigh, NC (US)

(73) Assignee: Caterpillar Inc., Peoria, IL (US)

(21) Appl. No.: 14/641,526

(22) Filed: Mar. 9, 2015

(51) Int. Cl. E02F 3/815; A01B 31/00; A01B 76/00; E02F 3/76

(52) U.S. Cl. CPC E02F 3/8152; E02F 3/7622; A01B 31/00; A01B 76/00

(57) ABSTRACT

A wear plate for a box blade is provided. The wear plate includes a first surface and a second surface. The first and second surfaces are spaced apart from each other and define a thickness of the wear plate therebetween. The wear plate also includes a plurality of openings formed on the wear plate and communicating with the first and second surfaces thereof. The plurality of openings is positioned along a diagonal axis of the wear plate. The plurality of openings is configured to be aligned with corresponding openings formed on a backer plate of the box blade to receive mechanical fasteners therethrough for attaching the wear plate to the backer plate. The wear plate includes a first wear surface defined on one side of the diagonal axis of the wear plate and a second wear surface defined on the other side of the diagonal axis.

### TECHNICAL FIELD

The present disclosure relates to a wear plate, and more particularly to a wear plate associated with a box blade of a machine.

### BACKGROUND

Machines, such as industrial loaders, include a box blade coupled to a rear section of the machine. The box blade is pulled behind the machine, and may be used to scrape, condition, and/or move loose soil or other materials on a ground from one place to another. As the box blade rides along the ground, side walls of the box blade may be subjected to wear. Hence, each side wall of the box blade is provided with a wear plate. The wear plates are subjected to the wear during machine operation, and are designed to be replaced after they wear beyond a certain point. Hence, the wear plates generally have a short operational life as they are subjected to wear during the machine operation.

U.S. Pat. No. 4,869,326, hereinafter referred to as the '326 patent, describes a box scraper for tractors and like vehicles. The box scraper comprises a box frame which supports, for pivotal movement, a pair of moldboards, horizontally spaced from each other for scraping a surface in either a forward or backward path. The box scraper also includes a pair of side plates which are spaced apart at a distance equivalent to the desired working/scraping width of the box scraper. The box scraper of the '326 patent further includes U-shaped wear plates coupled to ground engaging surface of each side plate. These U-shaped wear plates are bolted or otherwise attached to the side plates to protect the surface thereof.

### SUMMARY OF THE DISCLOSURE

In one aspect of the present disclosure, a wear plate for a box blade is provided. The wear plate includes a first surface and a second surface. The first and second surfaces are spaced apart from each other and define a thickness of the wear plate therebetween. The wear plate also includes a plurality of openings formed on the wear plate and communicating with the first and second surfaces thereof. The plurality of openings is positioned along a diagonal axis of the wear plate. The plurality of openings is configured to be aligned with corresponding openings formed on a backer plate of the box blade to receive mechanical fasteners therethrough for attaching the wear plate to the backer plate. The wear plate includes a first wear surface defined on one side of the diagonal axis of the wear plate and a second wear surface defined on the other side of the diagonal axis. Further, the wear plate is configured to be attached to the backer plate in a first configuration that presents the first wear surface for wear and a second configuration that presents the second wear surface for wear.

In another aspect of the present disclosure, a box blade is provided. The box blade includes a frame element comprising a first side, a second side, and a rear side. The box blade also includes a wear plate secured to the first side or the second side and is configured to ride along the ground. The wear plate includes a first surface and a second surface. The first and second surfaces are spaced apart from each other and define a thickness of the wear plate therebetween. The wear plate also includes a plurality of openings formed on the wear plate and communicating with the first and second surfaces thereof. The plurality of openings is positioned along a diagonal axis of the wear plate. The plurality of openings is configured to be aligned with corresponding openings formed on a backer plate of the box blade to receive mechanical fasteners therethrough for attaching the wear plate to the backer plate. The wear plate includes a first wear surface defined on one side of the diagonal axis of the wear plate and a second wear surface defined on the other side of the diagonal axis. Further, the wear plate is configured to be attached to the backer plate in a first configuration that presents the first wear surface for wear and a second configuration that presents the second wear surface for wear.

In another aspect of the present disclosure, a method of using a wear plate for a box blade is provided. The method includes attaching the wear plate to a side of the box blade. The method also includes removing the wear plate from the side of the box blade. The method further includes rotating the wear plate by 180 degrees with respect to the side of the wear plate. The method includes re-attaching the wear plate to the side of the box blade.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective view of an exemplary box blade associated with the machine of FIG. 1, according to one embodiment of the present disclosure;

FIG. 3 is an interior view of the box blade of FIG. 2;

FIG. 4 is an exploded view of a backer plate and a wear plate associated with the box blade, according to one embodiment of the present disclosure;

FIG. 5 is a perspective view of the wear plate associated with the box blade, according to one embodiment of the present disclosure;

FIG. 6 is a front view of an alternate design of the wear plate associated with the box blade, according to one embodiment of the present disclosure;

FIG. 7 is a side view of a first side of the box blade with the wear plate attached thereto, according to one embodiment of the present disclosure;

FIG. 8 is a side view of the first side of the box blade showing the wear plate in a worn condition, according to one embodiment of the present disclosure;

FIG. 9 is side view of the first side of the box blade showing the wear plate of FIG. 8 reversibly attached to the first side of the box blade, according to one embodiment of the present disclosure; and

FIG. 10 is a flowchart for a method of using a wear plate for a box blade.

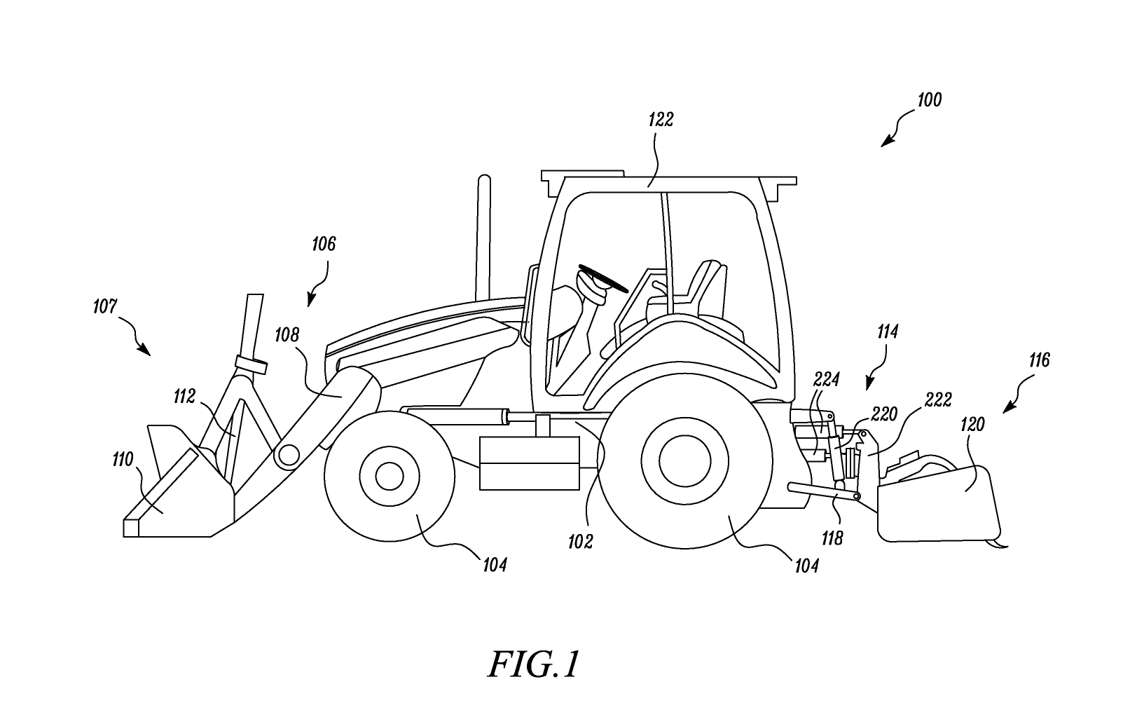

### DETAILED DESCRIPTION

Wherever possible, the same reference numbers will be used throughout the drawings to refer to the same or the like parts. Referring to FIG. 1, an exemplary machine 100 is illustrated. More specifically, the machine 100 is an industrial loader. Alternatively, the machine 100 may be any machine including, but not limited to, a backhoe loader, a wheel loader, an excavator, a shovel, a dozer, a mining truck, an articulated truck, a track type tractor, a forklift, a crane, skid steer loaders, compact track loaders, multi-terrain loaders, and so on. The machine 100 may be any machine known in the art associated with industries including, but not limited to, agriculture, transportation, mining, construction, forestry, landscaping, and material handling.

The machine 100 includes a frame 102. A power source (not shown) is provided on the frame 102 of the machine 100. The power source may be any power source known in the art, such as, an internal combustion engine, an electric motor, power storage device like batteries and a hybrid engine. The power source is configured to provide power to the machine 100 for operational and mobility requirements. The machine 100 includes a set of ground engaging members 104 embodied as wheels. The ground engaging members 104 are configured to provide mobility to the machine 100. The machine 100 also includes a drivetrain (not shown) coupled to the power source and the ground engaging members 104. The drivetrain may include a transmission system having one or more gears, shafts, differentials, torque convertor, hydraulic pump or motor and so on. The drivetrain may be configured to transmit motive power from the power source to the ground engaging members 104.

The machine 100 includes one or more implements, and associated components pivotally coupled to the frame 102. In the illustrated embodiment, a front implement arrangement 106 is provided at a front section 107 of the machine 100. The front implement arrangement 106 includes a front arm 108 pivotally coupled to the frame 102. An implement, such as, a front bucket 110 is pivotally affixed to the front arm 108. The front implement arrangement 106 also includes hydraulic and/or pneumatic cylinders 112 for providing a required spatial movement to the front arm 108 and the front bucket 110. It should be noted that the front bucket 110 may be replaced by any other implement as per system requirements. For example, the implement may include an auger, a blade, a fork, a hammer, a ripper, or any other implement.

Additionally, a rear implement arrangement 114 is provided at a rear section 116 of the machine 100. The rear implement arrangement 114 includes a rear arm 118 pivotally coupled to the frame 102. An implement, such as, a box blade 120 is pivotally affixed to the rear arm 118. The box blade 120 moves on the ground during operation of the machine 100. The rear implement arrangement 114 includes hydraulic and/or pneumatic cylinders 220 for providing a required spatial movement to the rear arm 118 (see FIG. 1).

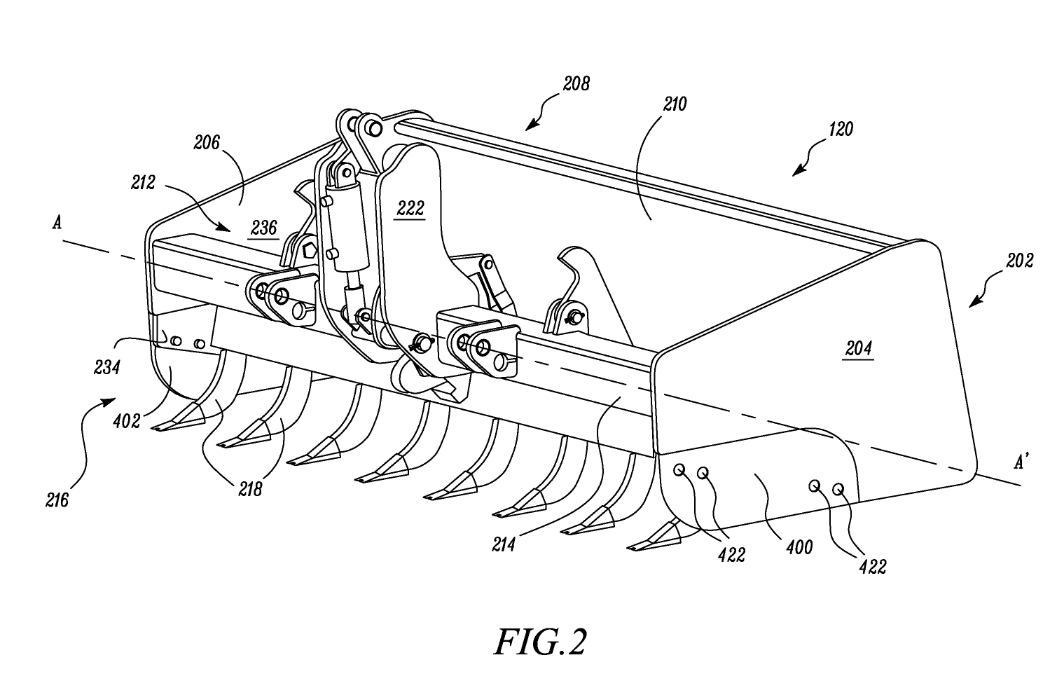

Referring to FIG. 2, the box blade 120 includes a frame element 202 having a first side 204 and a second side 206. The first and second sides 204, 206 are spaced apart from each other. The box blade 120 also includes a rear side 208 provided at a rear end 210 of the box blade 120. The rear side 208 transversely connects the first and second sides 204, 206 of the box blade 120.

In one embodiment of the present disclosure, the box blade 120 may optionally include a scarifier assembly 212 is associated with the box blade 120. The scarifier assembly 212 includes a scarifier bar 214 provided transversely between the first side 204 and the second side 206, at a front section 216 of the box blade 120. The scarifier assembly 212 includes a number of scarifier teeth 218. The scarifier teeth 218 are coupled to the scarifier bar 214. The scarifier teeth 218 are spaced apart at equal distances along a length of the scarifier bar 214. A number of the scarifier teeth 218 illustrated in the accompanying figures are exemplary and may vary based on system requirements.

The scarifier bar 214 is coupled to the frame 102 of the machine 100 through a bracket 222 and hydraulic and/or pneumatic cylinder 224 (see FIG. 1). The bracket 222 and the cylinders 224 together allow for a rotation of the scarifier bar 214 with respect to the box blade 120, based on operational requirements. The scarifier bar 214 rotates about an axis of rotation A-A′, to selectively engage and disengage the scarifier teeth 218 with the ground.

The front and rear implement arrangements 106, 114 are used for performing tasks, such as, earth moving, excavation, digging, demolition and the like. Further, the front and rear implement arrangements 106, 114 may be controlled electrically, mechanically, hydraulically, or pneumatically.

The machine 100 also includes an operator cabin 122 provided on the frame 102 of the machine 100. The operator cabin 122 includes an operator interface (not shown). The operator cabin 122 may include one or more input devices (not shown) such as, pedals, steering, joystick, knobs, levers, switches, display devices and so on. The input devices may be configured for operating and controlling one or more parameters of the front and rear implement arrangements 106, 114 and/or the machine 100.

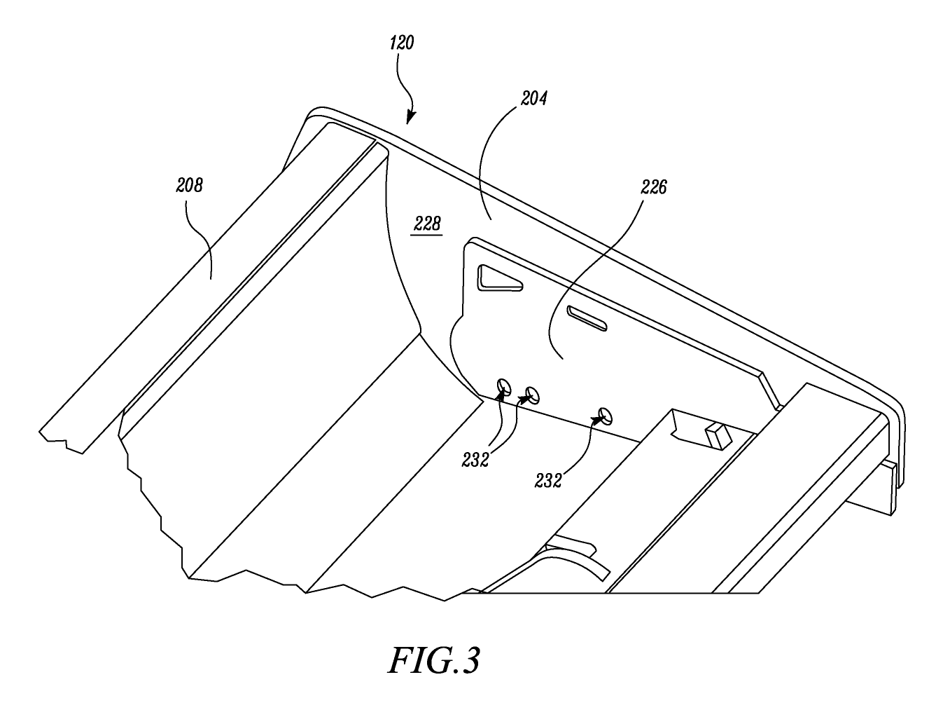

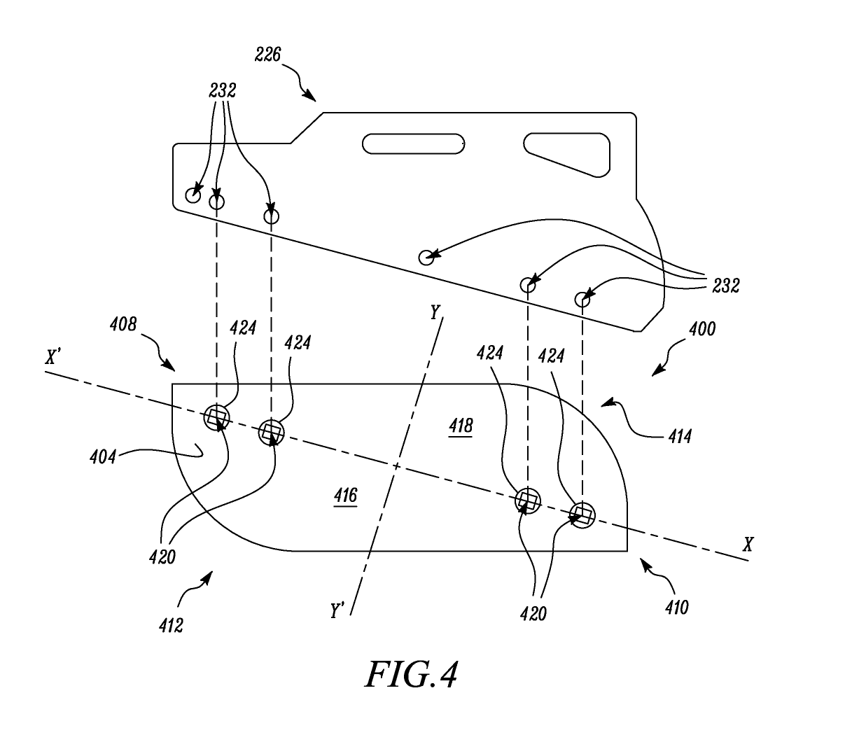

Referring to FIGS. 3 and 4, the box blade 120 includes a first backer plate 226 coupled to an inner surface 228 of the first side 204 of the box blade 120. The first backer plate 226 includes a plurality of openings 232 provided thereon. In one example, the first backer plate 226 of includes six openings 232 provided thereon. In another example, the first backer plate 226 may include four openings provided thereon. In yet another example, the first backer plate 226 may include five openings provided thereon. It should be noted that the openings 232 shown herein are exemplary, and do not limit the scope of the present disclosure.

The box blade 120 also includes a second backer plate 234 coupled to an inner surface 236 (see FIG. 2) of the second side 206 of the box blade 120. The backer plates 226, 234 may be made of any metal or non-metal known in the art. Further, the design of the backer plates 226, 234 shown in the accompanying figures are exemplary, and may vary without limiting the scope of the present disclosure. In one example, the backer plates 226, 234 may be welded to the first and second sides 204, 206 respectively. Alternatively, any other fastening means may be used to couple the backer plates 226, 234 to the respective sides 204, 206.

During operation, the box blade 120 rides along the ground. The box blade 120 and more particularly, the first and second sides 204, 206 of the box blade 120, are subject to wear at leading edges of the box blade 120. Therefore, the box blade 120 includes a pair of wear plates 400, 402 associated therewith. Referring to FIG. 2, the wear plate 400 is attached to the first side 204 of the box blade 120, via the first backer plate 226 (see FIG. 3). Additionally or optionally, the wear plate 402 is attached to the second side 206 of the box blade 120, via the second backer plate 234. The present disclosure will now be described in reference to the wear plate 400 with the first side 204 of the box blade 120.

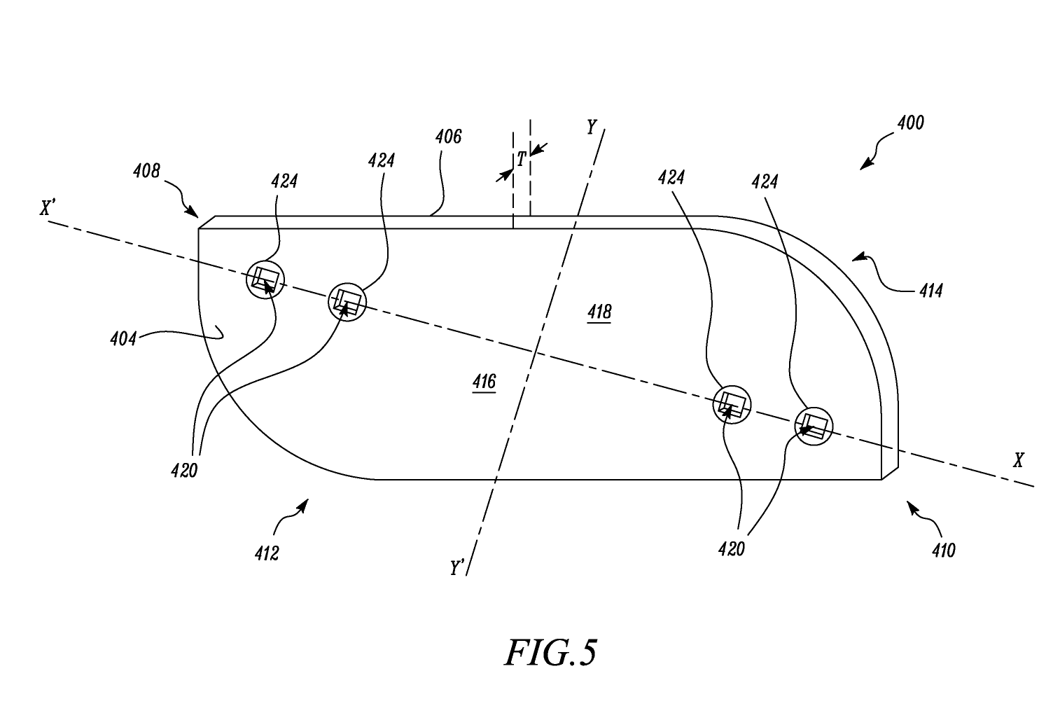

Referring to FIGS. 4, 5, and 6, the wear plate 400 includes a first surface 404 and a second surface 406 (see FIG. 5). The second surface 406 is spaced apart from the first surface 404. Further, the first and second surfaces 404, 406 define a thickness “T” (see FIG. 5) of the wear plate 400 therebetween. The wear plate 400 may be made of a metal or a non-metal, without limiting the scope of the present disclosure. The material of the wear plate 400 is selected such that the wear plate 400 exhibits resistance to wear and corrosion. The wear plate 400 has a diagonal axis X-X′. The wear plate 400 extends between a first end 408 and a second end 410 along the diagonal axis X-X′. The first and second ends 408, 410 may form approximately right angled corners.

The wear plate 400 includes a first side 412 and a second side 414 defined on either sides of the diagonal axis X-X′. The profile of the wear plate 400 has a pair of curved portions 411, 413 defined on the first side 412 and the second side 414 of the diagonal axis X-X′ respectively. The pair of curved portions 411, 413 is congruent to each other. The wear plate 400 includes a first wear surface 416. The first wear surface 416 is defined on the first side 412 of the diagonal axis X-X′. Further, the wear plate 400 includes a second wear surface 418 defined on the second side 414 of the diagonal axis X-X′.

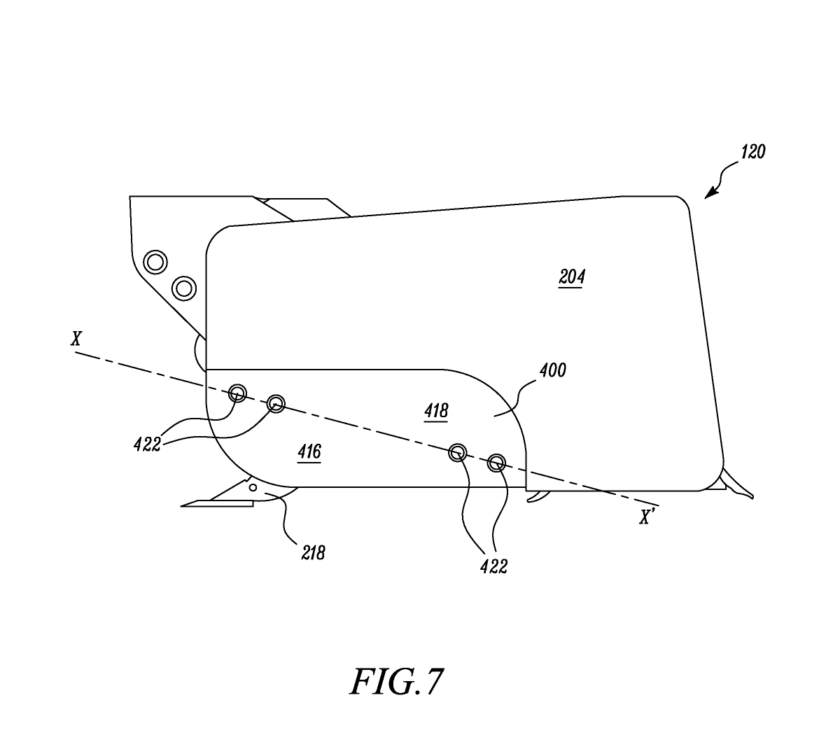

The wear plate 400 includes openings 420 formed thereon. The openings 420 are in communication with the first and second surfaces 404, 406 of the wear plate 400. The openings 420 are positioned along the diagonal axis X-X′ of the wear plate 400. In one example, the wear plate 400 includes same number of openings 420 provided about an axis Y-Y′, wherein that the axis Y-Y′ is perpendicular to the diagonal axis X-X′. It should be noted that a pattern of the openings 420 provided on the wear plate 400 is symmetrical about the diagonal axis X-X′ and the axis Y-Y′. In one embodiment, the wear plate 400 includes four openings 420, such that a pair of openings 420 is provided on either sides of the axis Y-Y′. The pair of openings 420 is provided proximate to the first and second ends 408, 410 of the wear plate 400 respectively. Each of openings 420 are configured to be aligned with corresponding openings 232 provided on the first backer plate 226 to receive mechanical fasteners 422 (see FIGS. 7-9) therethrough. The mechanical fasteners 422 are configured to attach the wear plate 400 to the first backer plate 226. The mechanical fasteners 422 may include any of a bolt, screw, pin, rivet, and the like. Alternatively, a weld stud may also be used to attach the wear plate 400 to the first backer plate 226. In one example, the openings 420 may be tapped and/or threaded to receive the mechanical fasteners 422 therein.

In one example, the mechanical fasteners 422 may embody a plow bolt. In such an example, the openings 420 include countersinks 424 (see FIGS. 4 and 5), so that the openings 420 may receive the plow bolts. It should be noted that based on the provision of the countersinks 424, the wear plates 400, 402 provided on the first and second sides 204, 206 may be different in design. Accordingly, in order to receive the wear plates 400, 402 of different designs, the backer plates 226, 234 may include multiple openings 232 for alignment with corresponding openings 420 of different designs of the wear plates 400, 402. In such embodiments, the same backer plate design may be provided at the first and second sides 204, 206 of the box blade 120. Thus, the backer plates 226, 234 are backward compatible with the wear plate design.

In an alternate example, the mechanical fasteners 422 may be carriage bolts. Accordingly, the openings 420 are square shaped to receive the carriage bolts therein. In yet another example, the mechanical fasteners 422 may embody a hexagonal bolt, and the openings 420 are circular in shape. In some embodiments, the openings 420 may include countersinks and/or counterbores corresponding to a shape of a bolt head of the mechanical fasteners 422, so that the bolt head is flushed with the first surface 404 of the wear plate 400. Further, in some examples, the bolt head may protrude from the first surface 404 of the wear plate 400. In such examples, the same wear plate design is applicable to the wear plates 400, 402 attached to the first and second sides 204, 206 of the box blade 120.

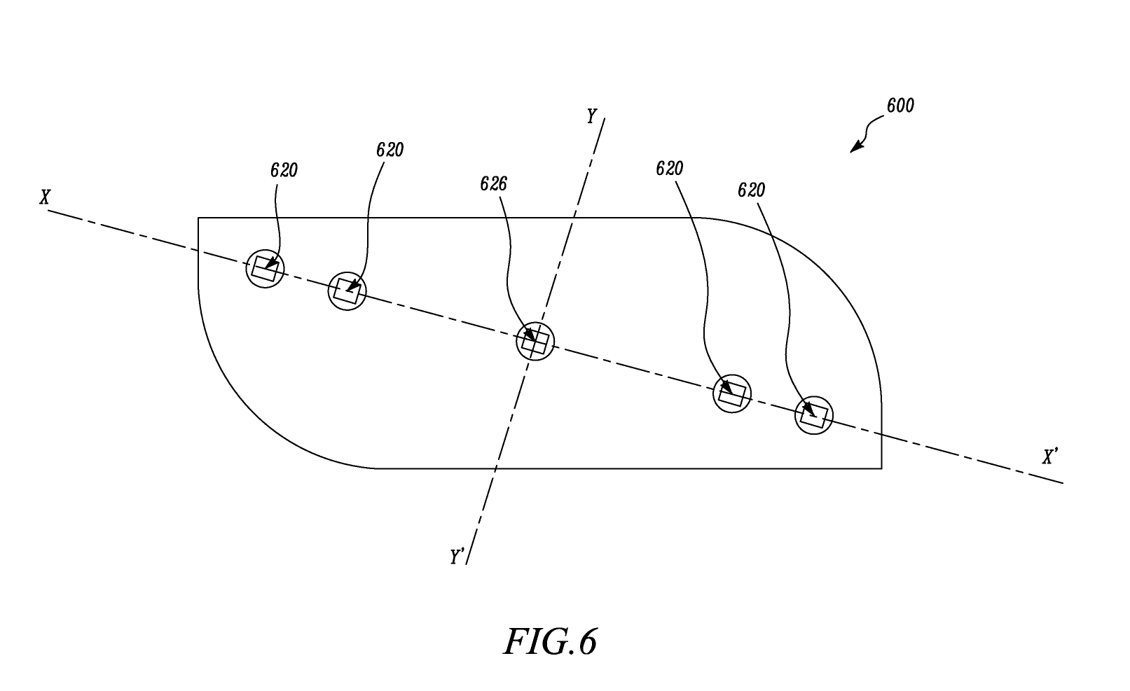

FIG. 6 illustrates a wear plate 602, according to one embodiment of the present disclosure. The wear plate 602 includes an opening 626 that is centrally positioned on the wear plate 602, in addition to the openings 620. The opening 626 is configured to be aligned with the corresponding opening 232 provided on the first backer plate 226 (see FIG. 4) to receive the mechanical fasteners 422 therein. It should be noted that a length of the mechanical fastener 422 provided in the openings 626 of the wear plate 602 and the first backer plate 226 respectively are decided such that the mechanical fastener 422 does not interfere with the scarifier bar 214 during the rotation thereof.

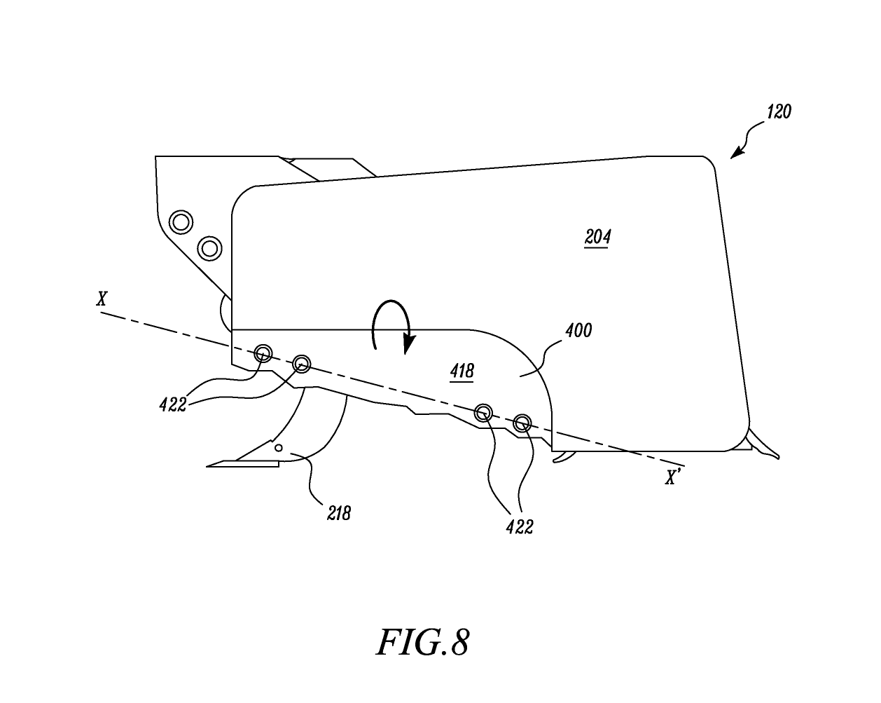

FIG. 7 shows the wear plate 400 of FIGS. 4 and 5 attached to the first side 204 in a first configuration. In the first configuration, the wear plate 400 is attached with the first backer plate 226 such that the first wear surface 416 of the wear plate 400 is configured to contact the ground and is presented for wear. Referring now to FIG. 8, after a period of time, the first wear surface 416 of the wear plate 400 may wear out due to contact with the ground. In such a situation, the wear plate 400 is removed from the first backer plate 226 by removing the mechanical fasteners 422.

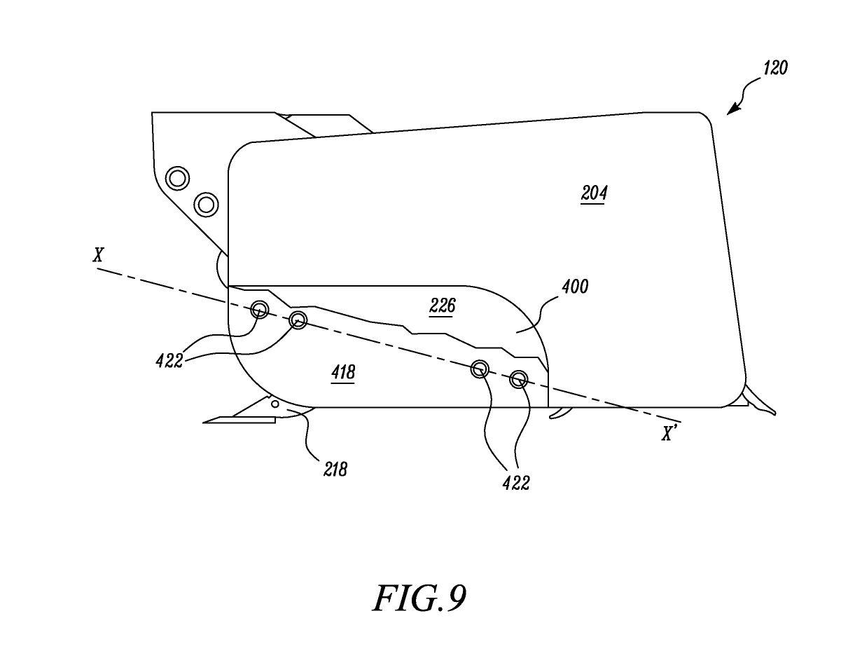

Referring now to FIG. 9, the wear plate 400 is reversed by rotating the wear plate 400 by 180 degrees (shown by arrow in FIG. 8) with respect to the first side 412 of the box blade 120. The wear plate 400 is then re-attached to the first backer plate 226, such that the wear plate 400 is in a second configuration. As shown in the accompanying figures, in the second configuration, the second wear surface 418 of the wear plate 400 is configured to contact the ground and is presented for wear. It should be noted that the wear plate 400 may be switched from the first configuration to the second configuration based on extent of wear of the given wear surface of the wear plate 400. For example, as shown in FIGS. 8 and 9, the operator may reverse the wear plate 400 in a situation wherein the wear experienced by the wear plate 400 approaches the openings 420 and the mechanical fasteners 422 that attach the wear plate 400 to the box blade 120.

### INDUSTRIAL APPLICABILITY

The present disclosure is directed towards wear plates 400, 402, 602 that are reversibly attached to the first and/or second sides 204, 206 of the box blade 120 respectively. The wear plates 400, 402, 602 may be attached to the box blade 120 in the first and/or second configuration. The first and second wear surfaces 416, 418 of the wear plates 400, 402, 602 are respectively presented for the wear in the first and second configuration of the wear plate 400, 402, 602. Once the first wear surface 416 of the wear plate 400, 402, 602 wears out, the wear plate 400, 402, 602 may be reversed from the first configuration to the second configuration. More particularly, the wear plate 400, 402, 602 may be removed from the box blade 120, rotated by 180 degrees and re-attached to the box blade 120. Thus, a wear life of the wear plates 400, 402, 602 may be doubled. This will in turn reduce owning and operating cost of the machine 100. Further, machine down time may also be reduced.

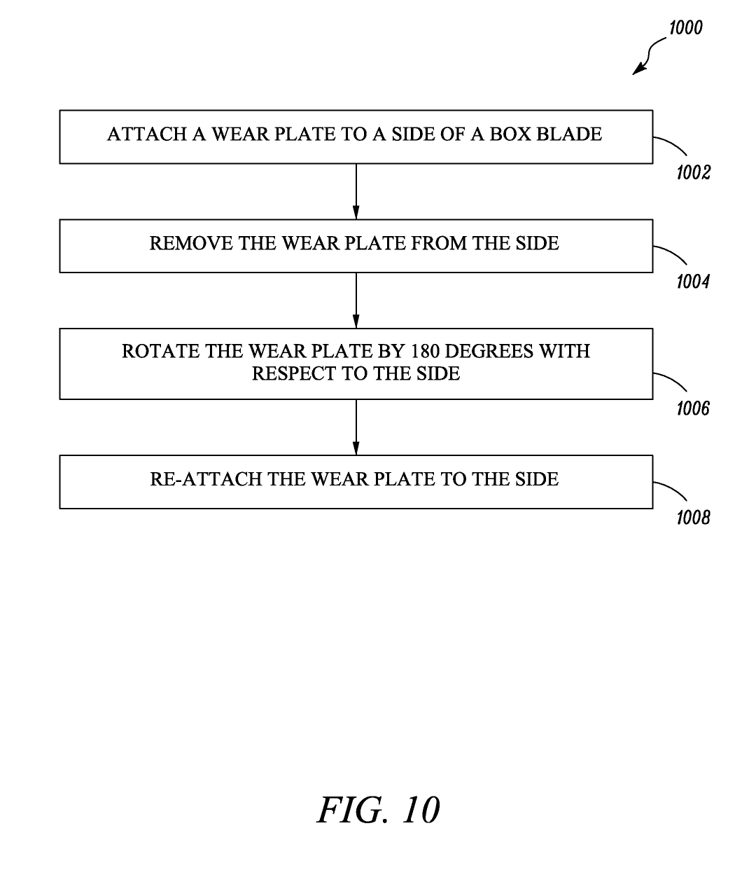

FIG. 10 is a flowchart for a method of using the wear plate 400 for the box blade 120. At step 1002, the wear plate 400 is attached to the first side 204 of the box blade 120. The wear plate 400 includes a plurality of openings 420 formed on the wear plate 400 positioned along the diagonal axis X-X′ of the wear plate 400. The openings 420 are aligned with corresponding openings 232 formed on the first backer plate 226 of the box blade 120. The plurality of openings 420 of the wear plate 400 and the corresponding openings 232 formed on the first backer plate 226 are configured to receive the mechanical fasteners 422 therethrough, to attach the wear plate 400 to the first side 204 of the box blade 120. Further, the wear plate 400 may be attached to the first side 204 in the first configuration such that the first wear surface 416 of the wear plate 400 is presented for the wear thereof. It should be noted that the first wear surface 416 is defined on the first side 412 of the diagonal axis X-X′ of the wear plate 400.

At step 1004, the wear plate 400 is removed from the first side 412 of the box blade 120. The wear plate 400 is removed from the first side 412 of the box blade 120 based on the wear of the first wear surface 416 of the wear plate 400. At step 1006, the wear plate 400 is rotated by 180 degrees with respect to the first side 412 of the box blade 120. The wear plate 400 is rotated such that the wear plate 400 is in the second configuration. In the configuration, the second wear surface 418 of the wear plate 400 is presented for the wear. The second wear surface 418 is defined on the second side 414 of the diagonal axis X-X′ of the wear plate 400. At step 1008, the wear plate 400 is re-attached to the first side 412 of the box blade 120.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A wear plate for a box blade, the wear plate comprising:
a first surface;
a second surface spaced apart from the first surface, the first and second surfaces defining a thickness of the wear plate therebetween; and
a plurality of openings formed on the wear plate and communicating with the first and second surfaces thereof, the plurality of openings being positioned along a diagonal axis of the wear plate, the plurality of openings configured to be aligned with corresponding openings formed on a backer plate of the box blade to receive mechanical fasteners therethrough for attaching the wear plate to the backer plate,
wherein a first wear surface is defined on one side of the diagonal axis of the wear plate and a second wear surface is defined on the other side of the diagonal axis, and
wherein the wear plate is configured to be attached to the backer plate in a first configuration that presents the first wear surface for wear and a second configuration that presents the second wear surface for wear.

2. The wear plate of claim 1, wherein the profile of the wear plate has a pair of curved portions defined on either sides of the diagonal axis.

3. The wear plate of claim 2, wherein each of the pair of curved portions is congruent to each other.

4. The wear plate of claim 1, wherein the wear plate extends between a first end and a second end, and wherein a pair of the plurality of openings is provided proximate to the first and second ends.

5. The wear plate of claim 1, wherein one of the plurality of openings is centrally positioned on the wear plate.

6. The wear plate of claim 1, wherein the plurality of openings on the wear plate is countersunk openings.

7. A box blade comprising:
a frame element comprising a first side, a second side, and a rear side; and
a wear plate secured to the first side or the second side and configured to ride along the ground, the wear plate including:
a first surface;
a second surface spaced apart from the first surface, the first and second surfaces defining a thickness of the wear plate therebetween; and
a plurality of openings formed on the wear plate and communicating with the first and second surfaces thereof, the plurality of openings being positioned along a diagonal axis of the wear plate, the plurality of openings configured to be aligned with corresponding openings formed on the backer plate of the box blade to receive mechanical fasteners therethrough for attaching the wear plate to the backer plate,
wherein a first wear surface is defined on one side of the diagonal axis of the wear plate and a second wear surface is defined on the other side of the diagonal axis, and
wherein the wear plate is configured to be attached to the backer plate in a first configuration that presents the first wear surface for wear and a second configuration that presents the second wear surface for wear.

8. The box blade of claim 7, wherein the profile of the wear plate has a pair of curved portions defined on either sides of the diagonal axis.

9. The box blade of claim 8, wherein each of the pair of curved portions is congruent to each other.

10. The box blade of claim 7, wherein the wear plate extends between a first end and a second end, and wherein a pair of the plurality of openings is provided proximate to the first and second ends.

11. The box blade of claim 7, wherein one of the plurality of openings is centrally positioned on the wear plate.

12. The box blade of claim 7, wherein the plurality of openings on the wear plate is countersunk openings.

13. A method of using a wear plate for a box blade, the method comprising:
attaching the wear plate to a side of the box blade;
removing the wear plate from the side;
rotating the wear plate by 180 degrees with respect to the side; and
re-attaching the wear plate to the side.

14. The method of claim 13, wherein the attaching step includes:
aligning a plurality of openings formed on the wear plate positioned along a diagonal axis of the wear plate, with corresponding openings formed on a backer plate of the box blade; and
receiving mechanical fasteners through the plurality of openings of the wear plate and the corresponding openings formed on the backer plate of the box blade.

15. The method of claim 13, wherein the attaching step further includes:
presenting a first wear surface of the wear plate for wear, wherein the first wear surface is defined on one side of a diagonal axis of the wear plate.

16. The method of claim 13, wherein the wear plate is removed from the side of the box blade on wear of the first wear surface of the wear plate.

17. The method of claim 13, wherein the rotating step further includes:
presenting a second wear surface of the wear plate for wear, wherein the second wear surface is defined on the other side of the diagonal axis of the wear plate.
